(19) United States
(12) Patent Application Publication
(10) Pub. No.: US 2025/0013999 A1
(43) Pub. Date: Jan. 9, 2025

(54) TAP-TO-SPLIT

(71) Applicant: Wells Fargo Bank, N.A., San Francisco, CA (US)

(72) Inventor: Joseph Franklin Janas, Lakeside, MI (US)

(21) Appl. No.: 17/663,114

(22) Filed: May 12, 2022

(51) Int. Cl. G06Q 20/10; G06Q 20/20; G06Q 20/32; G06Q 20/36

(52) U.S. Cl. CPC G06Q 20/102; G06Q 20/20; G06Q 20/3221; G06Q 20/3278; G06Q 20/36

(57) ABSTRACT

Systems and methods may generally include using proximate communication circuitry to automatically coordinate bill splitting among users with a mobile device. An example method may include receiving a bill, for example at a mobile wallet executing on the mobile device. The method may include receiving via the proximate communication circuitry, an indication from a second mobile device. A virtual account (e.g., of the mobile wallet) may be funded with a first amount drawn using information from the indication and a second amount drawn from an account of the mobile wallet. The method may include executing payment of the bill, such as with the mobile device.

### BACKGROUND

Since the advent of credit or debit cards, their use has increasingly become standard, while cash usage has dropped off significantly. Cards are far more useful, providing security, convenience, and data for financial planning. However, the increased usage of cards has heightened difficulties in splitting a bill or contributing to a common cost or amount due. Bill splitting has costs and inconveniences, such as awkward transactions and increased transaction fees.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for using proximate communication circuitry to automatically coordinate bill splitting among users with a mobile device in accordance with some embodiments.

FIG. 2 illustrates a user interface including a mobile wallet in accordance with some embodiments.

FIGS. 3-4 illustrate swim lane diagrams showing operations for automatic bill splitting in accordance with some embodiments.

FIG. 5 illustrates a flowchart showing a technique for include using proximate communication circuitry to automatically coordinate bill splitting among users with a mobile device in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide a technological framework to facilitate splitting a bill or an amount due. A dilemma often occurs when two or more people are faced with a bill (e.g., at a restaurant) where different charges are allocated to different people. Sometimes a single person pays the entire bill and is potentially reimbursed later, or on a different date (e.g., “I'll pay this one, you get the next one”). Other times people attempt to manually split a bill by using cash. Technology on the merchant side of a transaction has introduced some flexibility where people can pay with different credit cards where the merchant splits the bill. However, this increases transaction costs, because multiple small transactions may each have minimum fees that are higher than a combined fee (e.g., credit card processing fees, which may be a percentage, such as 3%, but with a minimum, such as $1). None of these solutions provides any technical mechanism to facilitate bill splitting.

The systems and techniques described herein solve the technological problem of bill splitting with a technical solution that uses a mobile device to act as an intermediary between people paying a bill (e.g., those who wish to split the bill) and a merchant. The technological problem is a structural one that includes communication issues, messaging format issues, and authorization or authentication issues, rather than being a monetary problem. The technological problem of communicating distribution and allocation of resources is solved by the technical solutions provided herein.

One example technical advantage provided by the technical solutions set forth herein is that by staging bill splitting on one mobile device, only one payment must be made to settle the bill. This is unlike current bill splitting technologies where the merchant must swipe two cards and cause two separate payments. Therefore, the current systems and techniques described herein reduce merchant transaction fees and the amount of data sent between the merchant and the issuing bank (e.g., via the credit card acquirer/processor). Because of the inherent limitations in the time that each transaction takes, one aspect of the technical advantages provided by the systems and techniques described herein includes speeding up the total transaction time (e.g., by eliminating one or more transactions needed to completely pay a bill). Another technical improvement to mobile bill pay technology of the systems and techniques described herein includes reducing the likelihood of errors by eliminating some human input (e.g., eliminating a need for a merchant to enter different amounts to split a bill manually, eliminating a need for a merchant to provide a correctly split bill to a correct party, eliminating a need for a merchant to return cards/devices to correct parties, etc.).

A first mobile device may be used to communicate with one or more other mobile devices to receive payment information (e.g., payment amount, payment source, etc.). The first mobile device may communicate with a merchant device to complete a transaction to pay a bill. These communications may be performed using different channels (e.g., using 4G or 5G technology for mobile device to mobile device communications, and near field communications (NFC) technology or other close-range communications for the mobile device to merchant device communication). In other examples, communications may use a same channel (e.g., NFC), but with different security protocols or at different times.

The present systems and techniques may use a mobile wallet executing on a mobile device. The mobile wallet may include an application (e.g., an “app”) running on the mobile device. The mobile wallet may include a user interface for initiating a bill splitting mode. The mobile wallet may be linked to one or more accounts, such as a checking or savings account, a credit or debit card, a line of credit, or the like. The mobile wallet may include security provisions to maintain safety when communicating financial or payment information among devices. The mobile device may receive payment information from one or more other mobile devices and optionally pay a bill. In other examples, a person operating the mobile device may receive bill splitting payment information via the mobile wallet from one or more other mobile devices, but pay the bill using a separate method (e.g., with a credit card).

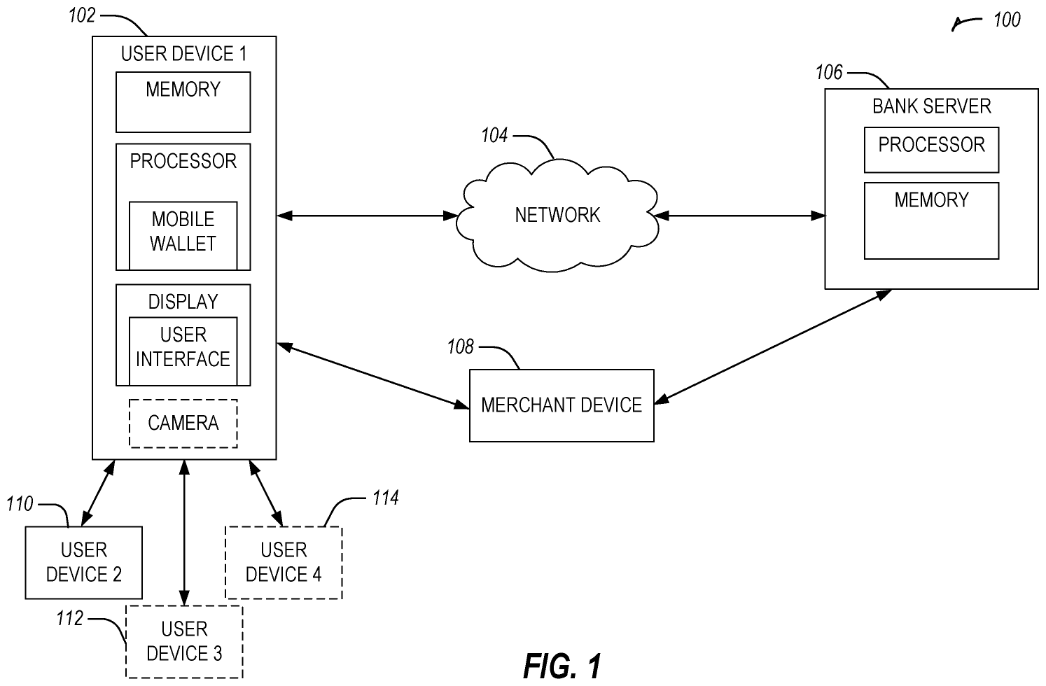

FIG. 1 illustrates a system 100 for using proximate communication circuitry to automatically coordinate bill splitting among users with a mobile device in accordance with some embodiments. The system 100 includes a first user device 102, and at least one other user device 110 (and optionally 112, 114, etc.). The system 100 includes a merchant device 108, in communication with the first user device 102. The system 100 may include a network 104, for example the internet, to facilitate communications between or among the first user device 102, the merchant device 108, and a bank server 106, in some examples. In an example, the at least one other user device (e.g., 110, 112, 114, or the like) may communicate with the first user device 102 using the network 104, while in other examples, a user device or the merchant device 108 may communicate using a direct communication technique (e.g., NFC, Wi-Fi direct, etc.). The first user device 102 may include memory, a processor (e.g., for executing a mobile wallet), a display (e.g., for presenting a user interface, such as a user interface corresponding to the mobile wallet), and optionally a camera.

In a first example, the first user device 102 may receive a bill from the merchant device 108. After the bill is received, the first user device 102 may communicate with the at least one other user device (e.g., 110, 112, 114, or the like) to obtain payment information for each user's portion of the bill. The payment information may include account information (e.g., a credit or debit card number, an account number, etc.), and optionally a payment amount or an expiration time for use of the payment information by the first user device 102. The first user device 102 may then pay the bill by communicating with the merchant device 108. The bill may be paid in response to receiving payment information from each of the at least one other user device (e.g., 110, 112, 114, or the like).

In a second example, the first user device 102 may communicate with the at least one other user device (e.g., 110, 112, 114, or the like) to obtain preliminary payment information. The preliminary payment information may include account information (e.g., a credit or debit card number, an account number, etc.), and optionally a maximum payment amount, a payment amount range, an expiration time for use of the payment information by the first user device 102, a location restriction for use of the payment information by the first user device 102, or the like. After receiving the preliminary payment information, the first user device 102 may communicate with the merchant device 108. The merchant device 108 may send a bill (e.g., when a merchant selects to send a bill, or in response to a request for the bill from the first user device 102) to the first user device 102. The mobile wallet of the first user device 102 may determine an amount due by each of the first user device 102 and the at least one other user device (e.g., 110, 112, 114, or the like). The amount due may be equally divided among or between the user devices, may be allocated according to the bill, may be allocated according to the preliminary payment information, in accordance with any restrictions on payments limits, or the like. The bill may be paid by the first user device 102 in communication with the merchant device 108, or by another method (e.g., a credit or debit card, cash, etc.). The first user device 102 may communicate with the at least one other user device (e.g., 110, 112, 114, or the like) to obtain final payment information, such as confirmation of a respective amount due.

In a third example, the user device 110 may send a request to split a bill to the first user device 102. The request may include payment information or preliminary payment information. In response, the first user device 102 may communicate with the merchant device 108 to pay the bill. Optionally, before paying the bill, the first user device 102 may receive the bill, confirm with the user device 110, or solicit payment information from another user device (e.g., 112 or 114).

In a fourth example, the first user device 102 may capture a bill, for example using a camera of the first user device 102. The first user device 102 may process the captured bill to determine an amount due, such as a total amount due, an amount due per person (e.g., when the captured bill includes a seat number for each item or a total divided by a number of people who are paying), or the like. The first user device 102 may use the determined amount due to communicate with the at least one other user device (e.g., 110, 112, 114, or the like), and receive back payment information. In some examples, the first user device 102 may then pay the bill, for example in communication with the merchant device 108. In other examples, the first user device 102 may receive the payment information and another payment method may be used (e.g., a credit or debit card, cash, etc.).

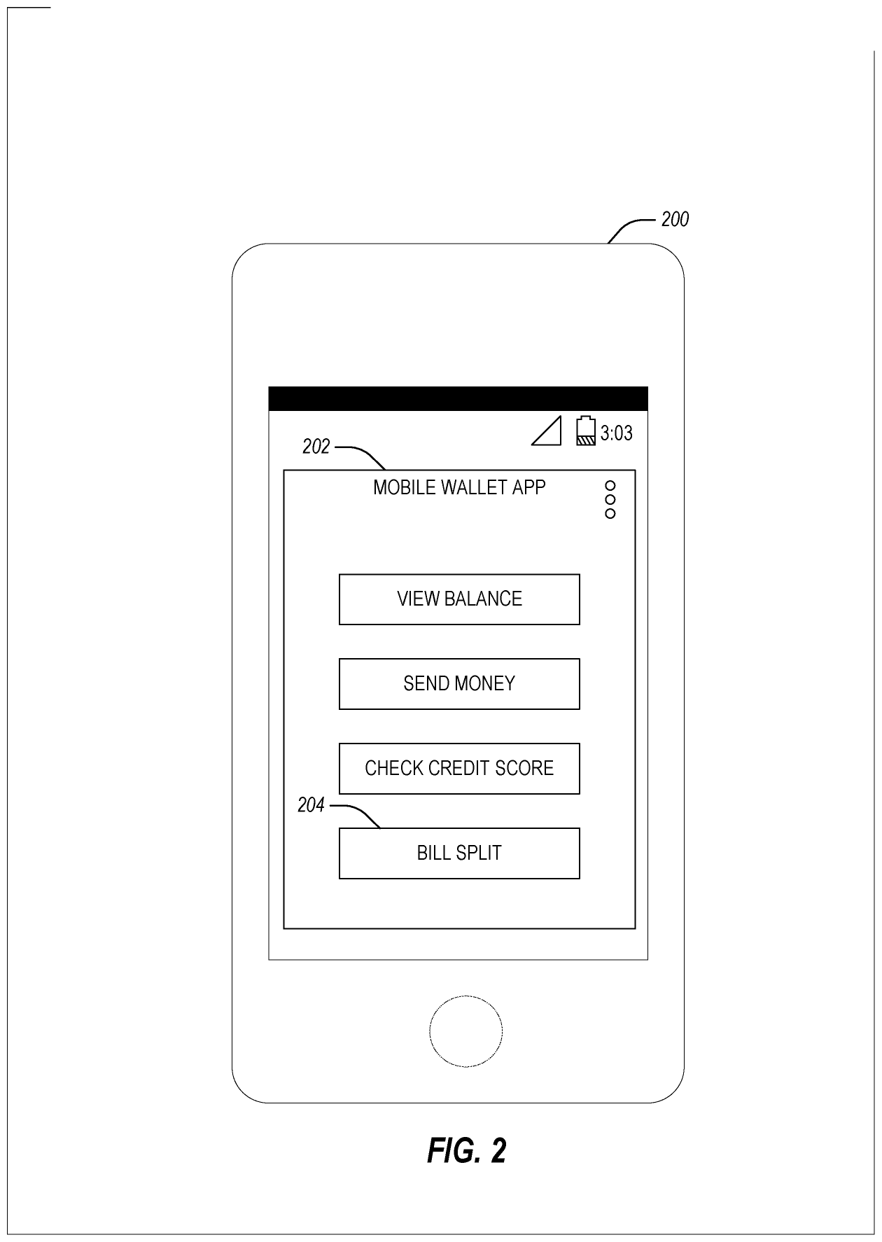

FIG. 2 illustrates a mobile device 200 displaying a user interface including a mobile wallet app 202 in accordance with some embodiments. The mobile wallet app 202 may be used to perform any number of banking or communication actions, such as viewing a balance, sending money, checking a credit score, applying for a loan, etc. One example action of the mobile wallet app 202 may include a bill split action, which may be activated by selection of a bill split indication 204 on the user interface.

A user of the mobile device 200 may select the bill split indication 204 on the user interface to generate a bill split mode for the mobile device 200. The bill split mode may activate communication circuitry of the mobile device 200 in some examples. The bill split mode may be used to receive payment information from another mobile device or to communicate with a merchant device to pay a bill.

In some examples, payment information received at the mobile device 200 may be preliminary (e.g., require later confirmation, provide only partial information, etc.) or may include a limit, such as a time limit (e.g., 5, 10, 30 minutes, etc.), an amount limit or range (e.g., not to exceed $30), a location limit (e.g., within a particular distance (e.g., 100 feet) of a current location of the sending mobile device or of a merchant address), a use category limit (e.g., payment for a restaurant), or the like.

The mobile wallet app 202 may correspond to a particular financial institution or be general to a set of financial institutions or all financial institutions. The mobile wallet app 202 may include a bank account. When a user device sends payment information to the mobile device 200, the mobile wallet app 202 may determine whether the payment information includes a bank that matches the bank account of the mobile wallet app 202. In this case, the mobile wallet app 202 may facilitate transfer of funds between accounts within the environment of the matching bank. When the bank does not match the bank account, the mobile wallet app 202 may generate a payment request, which may be sent to the bank or to the other user device.

The mobile wallet app 202 may receive payment information from a user device via NFC, Bluetooth, chip, or the like. Payment may be received at the mobile wallet app 202 or via remote financial transaction (e.g., an ACH transfer). In some examples, mobile wallet app 202 may receive payment information directly from a card, such as a credit or debit card (e.g., via NFC or chip).

The mobile device 200 may communicate with another user device to obtain payment information. The communication may include using NFC, Bluetooth, Wi-Fi direct, 4G, 5G, etc. The communication may include a communication by tapping the phones together, through a message, via email, etc. A user may select a contact to communicate with, and the communication may be initiated by the mobile wallet app 202, in some examples.

In an example, when paying a bill that is to be split, the mobile device 200 may pre-stage the bill, and send a payment request to a secondary user. In another example, the mobile device 200 may pay the bill, and then communicate with a secondary user. In still another example, a secondary user may tap the mobile device 200 (e.g., with another mobile device or a card), and the mobile device 200 may pay bill after the tap. In some of these examples, a secondary user may have a second communication with the mobile device 200 to approve the payment.

The mobile wallet app 202 may be used to pay the bill (e.g., with a credit card or other account of the mobile wallet app 202). After payment, the bill may be reimbursed based on a secondary user payment information (e.g., via the tap). In some examples, the bill may be pre-staged to split using the mobile wallet app 202. In these examples, a message may be sent to an issuer bank (e.g., corresponding to an account of the mobile wallet app 202) about the split transaction. The message may indicate an amount and a merchant, such that when that transaction occurs, the issuer bank may fund the transaction and apply the split-funded money to pay off the transaction.

In some examples, the mobile wallet app 202 may receive payment information from another mobile device via a token. The token may include account information, payment limits (e.g., time, location, etc.), or the like. The token may include a security provision. The token may be formatted according to a standard (e.g., according to a payment token specification, such as an EMV Payment Tokenization Specification propagated by EMVCo, LLC). A token may include an identifier, and may respond to a request from the mobile device 200. The token may be received via a tap.

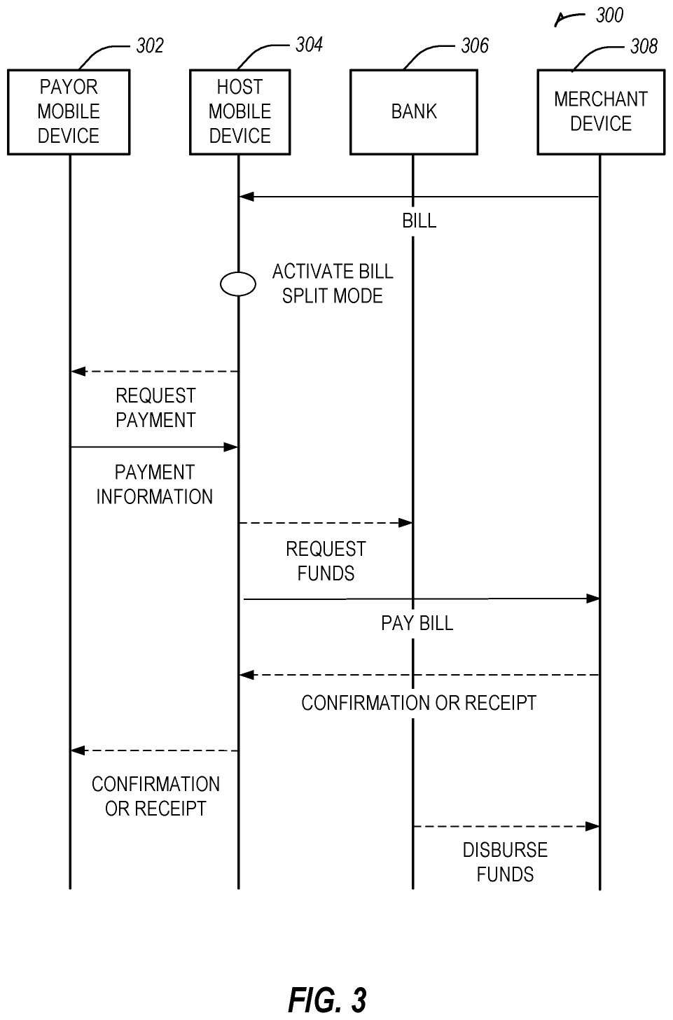

FIG. 3 illustrates a swim lane diagram 300 showing operations for automatic bill splitting in accordance with some embodiments. The swim lane diagram 300 is shown with a host mobile device 304 (e.g., the mobile device 200 of FIG. 2, the first user device 102 of FIG. 1, etc.), a payor mobile device 302 (e.g., one or more of the other user devices 110, 112, 114, etc. of FIG. 1, or the like), a financial institution (labeled “bank 306”, but this entity may include one or more banks, credit unions, credit card companies, or other financial institution or payment facilitator), and a merchant device 308 (e.g., the merchant device 108 of FIG. 1, or the like).

The swim lane diagram 300 is initiated by the host mobile device 304 receiving a bill (e.g., via the merchant device 308, but alternatively by capturing an image with a camera of a bill, by manual entry of a bill or bill information, etc.). The host mobile device 304 may activate a bill split mode (e.g., in response to receiving the bill, in response to selection of an indication on a user interface of the host mobile device 304, etc.). The host mobile device 304 may optionally request payment information from the payor mobile device 302. The request may include an amount due (e.g., a total bill, an amount owed by the user of the payor mobile device 302, the total bill divided by a number of payors, or the like).

Either in response to the optional request for payment information or on its own, the payor mobile device 302 may send payment information to the host mobile device 304. The payment information may include an account to draw payment from to satisfy a portion of the bill. In some examples, the payment information may include a number of people being paid for by the payor mobile device 302 (e.g., when two or more people are using a single payor mobile device to pay for their portions of the bill, such as couples).

After receiving the payment information from the payor mobile device 302, the host mobile device 304 may optionally request funds from the bank 306. This operation may include requesting a hold, requesting payment from an account of the payor mobile device 302, etc. The host mobile device 304 may pay the bill after receiving the payment information from the payor mobile device 302. To pay the bill, the host mobile device 304 may send a single payment method to the merchant device 308. In other examples, the host mobile device 304 may send multiple payment methods (e.g., one for the host mobile device 304 and one for the payor mobile device 302) to the merchant device 308.

In response to the host mobile device 304 paying the bill, optional operations may be performed. One optional operation includes sending a confirmation or receipt from the merchant device 308 to the host mobile device 304. Another optional operation includes sending a confirmation or receipt from the host mobile device 304 to the payor mobile device 302. Yet another optional operation includes the bank 306 disbursing funds to the merchant device 308. In some examples, the bank 306 may send a confirmation or receipt to the host mobile device 304 or the payor mobile device 302.

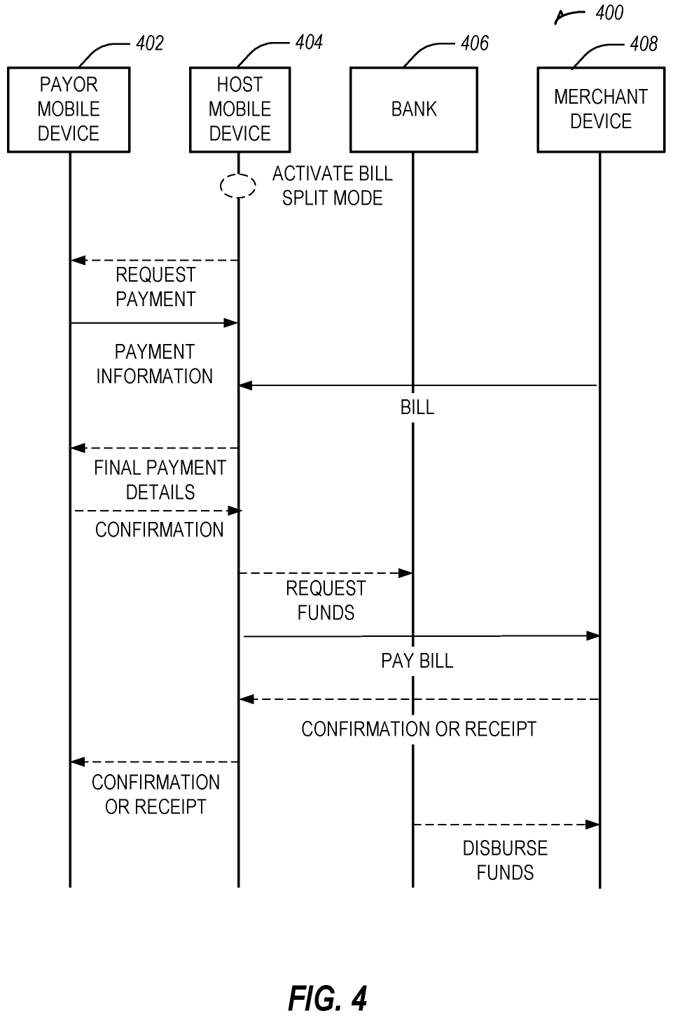

FIG. 4 illustrates a swim lane diagram 400 showing operations for automatic bill splitting in accordance with some embodiments. The swim lane diagram 400 is shown with a host mobile device 404 (e.g., the mobile device 200 of FIG. 2, the first user device 102 of FIG. 1, the host mobile device 304 of FIG. 3, etc.), a payor mobile device 402 (e.g., one or more of the other user devices 110, 112, 114, etc. of FIG. 1, the payor mobile device 302 of FIG. 3, or the like), a financial institution (labeled “bank 406”, but this entity may include one or more banks, credit unions, credit card companies, or other financial institution or payment facilitator), and merchant device 408 (e.g., the merchant device 108 of FIG. 1, the merchant device 308 of FIG. 3, or the like).

The swim lane diagram 400 optionally starts with the host mobile device 404 being used to activate a bill split mode (e.g., on a mobile wallet running on the host mobile device 404). When initiated by activating the bill split mode, the swim lane diagram 400 may optionally include requesting payment information from the payor mobile device 402 by the host mobile device 404. In another example, when initiated by activating the bill split mode, the swim lane diagram 400 may proceed to receiving payment information at the host mobile device 404 from the payor mobile device 402. When not initiated by the bill split mode activation at the host mobile device 404, the swim lane diagram 400 may initiate with a payment information request from the host mobile device 404 to the payor mobile device 402.

When the bill split mode is activated at the host mobile device 404, the payor mobile device 402 may send (e.g., via message, tap, etc.) payment information to the host mobile device 404, whether the payment information request was sent or not. When the bill split mode is not activated (e.g., omitted), the payor mobile device 402 may send (e.g., via message, tap, etc.) payment information to the host mobile device 404 in response to the payment information request sent by the host mobile device 404.

The payment information sent by the payor mobile device 402 to the host mobile device 404 may be preliminary or partial payment information. For example, the payment information sent may include a range or limit for money to be accessible to pay a bill, may indicate a time or location limit to prevent fraud, or may include encrypted or tokenized payment information. For example, account payment information may be encrypted or tokenized in a way that prevents use by the host mobile device 404 until the payor mobile device 402 further acts (e.g., sends a key to the host mobile device 404, authorizes a transaction via the bank 406, sends a confirmation to the merchant device 408, or the like).

The host mobile device 404 may receive a bill (e.g., from the merchant device 408, via a camera capturing an image of a bill, via manual input of a bill or information corresponding to a bill, or the like). The host mobile device 404 may pay the bill, with or without one or more of the following optional intervening operations. A first optional operation may include sending final payment details to the payor mobile device 402, from the host mobile device 404. The final payment details may include an amount due (e.g., a total amount due, a portion due, such as divided evenly, or based on an amount identified in the bill as corresponding to the payor mobile device 402, etc.). The payor mobile device 402 may optionally send a confirmation to the host mobile device 404, for example in response to receiving the final payment details (e.g., and optionally after a user of the payor mobile device 402 reviews and selects to confirm a transaction). In another example, the payor mobile device 402 may optionally send a confirmation based on an out of band communication (e.g., a notification from the bank 406 that funds were requested, a verbal or other human communication between users of the host mobile device 404 and the payor mobile device 402, a text or email message sent by the host mobile device 404 to the payor mobile device 402, or the like). A third optional operation may include requesting funds from the bank 406 in a message sent via the host mobile device 404. The request for funds may include a request for funds of a payor account, a host account, etc.

After paying the bill, optional operations may be performed, as detailed in the swim lane diagram 400. For example, an optional operation may include sending a confirmation or receipt from the merchant device 408 to the host mobile device 404. Another optional operation includes sending a confirmation or receipt from the host mobile device 404 to the payor mobile device 402 (e.g., in response to the confirmation sent by the payor mobile device 402 to the host mobile device 404, which may occur before the bill is paid, in some examples, such as when the host mobile device 404 receives payment from an account of the payor mobile device 402). Yet another optional operation includes the bank 406 disbursing funds to the merchant device 408. In some examples, the bank 406 may send a confirmation or receipt to the host mobile device 404 or the payor mobile device 402.

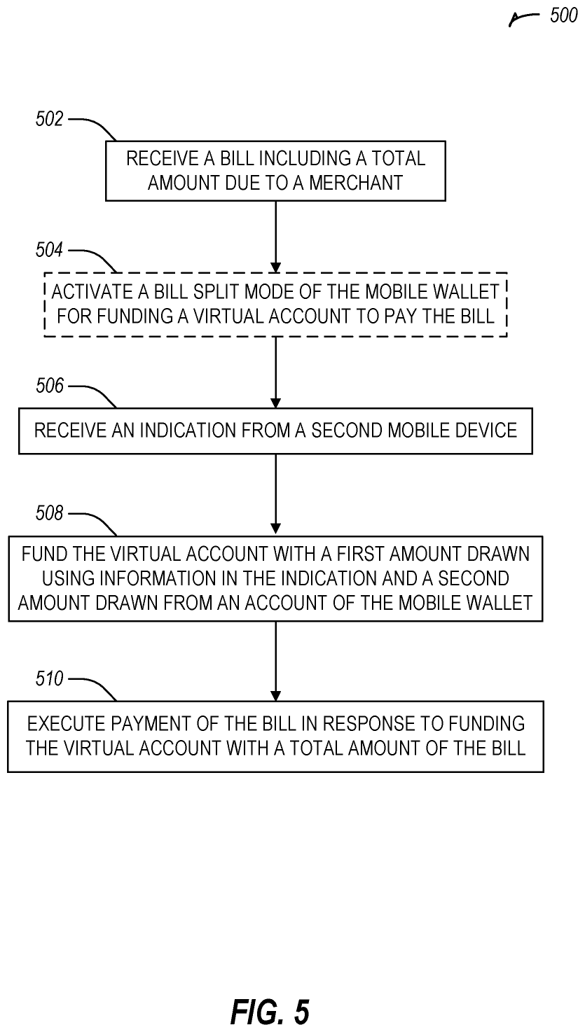

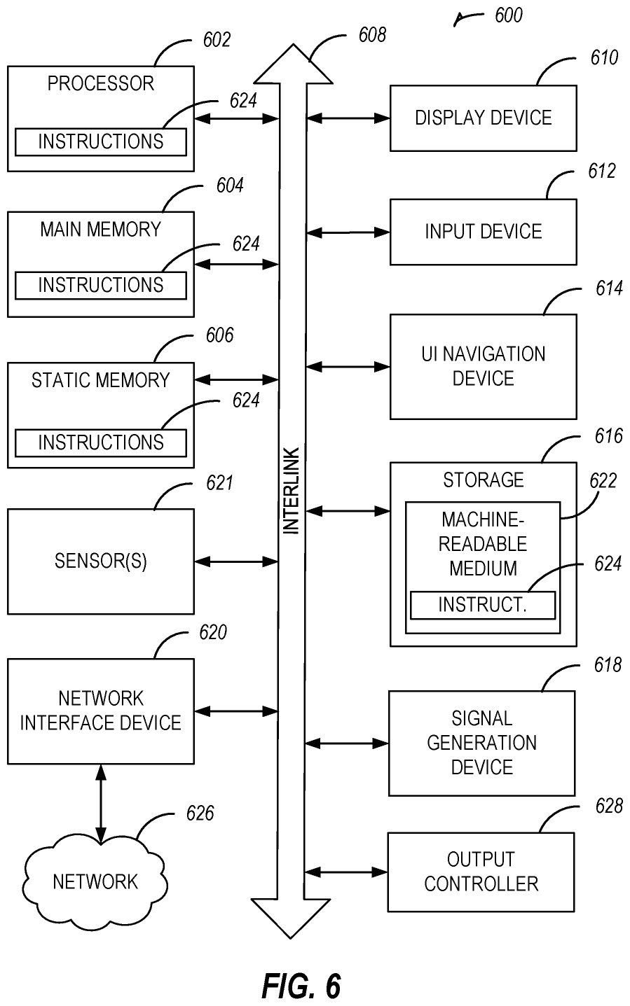

FIG. 5 illustrates a flowchart showing a technique 500 for using proximate communication circuitry to automatically coordinate bill splitting among users with a mobile device in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 1 or 6.

The technique 500 includes an operation 502 to receive, for example at a mobile wallet executing on a mobile device, a bill including a total amount that is due to a merchant. In an example, operation 502 includes capturing, using a camera of the mobile device, an image of the bill and extracting the total amount from the image. An amount (e.g., the second amount discussed below) may be identified based on a user selection in the mobile wallet of a line item of the bill generated from the image. The user selection may be done on at the mobile device or at the second mobile device discussed below.

The technique 500 includes an operation 504 to activate, for example using a processor of the mobile device, a bill split mode of the mobile wallet for funding a virtual account to pay the bill. In some examples, the virtual account is a virtual card. The virtual card may be a debit card, credit card, or stored value card that is issued without any corresponding physical (e.g., plastic) card. The funds associated with the virtual card may be accessed without a physical card. In other examples, the virtual account may include a transaction specific account, a special payment account, etc., which may be funded via a savings or checking account, via a credit card, or the like. In some examples, the virtual account may be created (e.g., by the mobile wallet) to pay the bill, and the virtual account may be removed after paying the bill.

Operation 504 may include activating the bill split mode based on a user selection on a display device of the mobile device. The technique 500 includes an operation 506 to receive, for example via near-field communication (NFC) circuitry of the mobile device, an indication from a second mobile device, the indication including payment information. The indication may include a limit to the first amount. The indication may include a time limit for executing payment of the bill with the payment information.

The technique 500 includes an operation 508 to fund the virtual account with a first amount drawn via the payment information and a second amount drawn from an account of the mobile wallet. In some examples, the first and second amounts drawn may be each equal to half of a total amount of a bill. In other examples, the first amount and the second amount are different amounts that, when added together, equal the total amount of the bill. Operation 508 may include funding the virtual account with a third amount received via a second indication including second payment information from a third mobile device.

The technique 500 includes an operation 510 to execute payment of the bill, in response to funding the virtual account with a total amount of the bill, for example using the mobile device, the virtual account, a credit card, a debit card (e.g., tied to the virtual account), etc. Operation 510 may include using the NFC circuitry of the mobile device to communicate with a point of sale device of the merchant.

The technique 500 may include displaying, in a user interface corresponding to the mobile wallet on a display device of the mobile device, an image corresponding to the payment information of the second mobile device in response to receiving the indication. The technique 500 may include sending a payment request to the second mobile device. In this example, receiving the indication from the second mobile device may include receiving the indication in response to the payment request.

In some examples, the bill may be pre-staged, such as by sending an amount of the bill prior to receiving the indication in operation 506. In some examples, the bill may be paid by the mobile device before the indication is received from the second mobile device. In some examples, the second mobile device may send the indication without fully authorizing payment, which may be received after the bill is paid. In some examples, instead of receiving the indication from NFC circuitry, the indication may be received via another communication method, such as email, text message, message via bank server, etc. The indication may be prompted by the mobile device initiating a communication with the second mobile device in some examples.

The technique 500 may include using a token. The token may have identification information, where a primary device (e.g., the mobile device) seeds a request to the second mobile device. The token may be used to receive payment from the second mobile device. In some examples, the token may be applied to a credit card balance after bill payment (e.g., payment of the bill using the credit card).

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving, at a mobile wallet executing on a mobile device, a bill including a total amount that is due to a merchant; activating, using a processor of the mobile device, a bill split mode of the mobile wallet for funding a virtual account to pay the bill; receiving, via near-field communication (NFC) circuitry of the mobile device, an indication from a second mobile device, the indication including payment information; funding the virtual account with a first amount drawn via the payment information and a second amount drawn from an account of the mobile wallet; and executing payment of the bill, in response to funding the virtual account with a total amount of the bill, using the mobile device.

In Example 2, the subject matter of Example 1 includes, wherein the first and second amount are each equal to half of the total amount of the bill.

In Example 3, the subject matter of Examples 1-2 includes, wherein activating the bill split mode includes activating the bill split mode based on a user selection on a display device of the mobile device.

In Example 4, the subject matter of Examples 1-3 includes, wherein funding the virtual account includes funding the virtual account with a third amount received via a second indication including second payment information from a third mobile device.

In Example 5, the subject matter of Examples 1-4 includes, displaying, in a user interface corresponding to the mobile wallet on a display device of the mobile device, an image corresponding to the payment information of the second mobile device in response to receiving the indication.

In Example 6, the subject matter of Examples 1-5 includes, wherein the first amount and the second amount are different amounts that, when added together, equal the total amount of the bill.

In Example 7, the subject matter of Examples 1-6 includes, wherein executing payment of the bill includes using the NFC circuitry of the mobile device to communicate with a point of sale device of the merchant.

In Example 8, the subject matter of Examples 1-7 includes, wherein the indication received from the second mobile device includes a limit to the first amount.

In Example 9, the subject matter of Examples 1-8 includes, wherein the indication received from the second mobile device includes a time limit for executing payment of the bill with the payment information.

In Example 10, the subject matter of Examples 1-9 includes, sending a payment request to the second mobile device, and wherein receiving the indication from the second mobile device includes receiving the indication in response to the payment request.

In Example 11, the subject matter of Examples 1-10 includes, wherein receiving the bill includes capturing, using a camera of the mobile device, an image of the bill and extracting the total amount from the image.

In Example 12, the subject matter of Example 11 includes, identifying the second amount based on a user selection in the mobile wallet of a line item of the bill generated from the image.

Example 13 is at least one non-transitory machine-readable medium including instructions for operation of a mobile wallet on a mobile device, which when executed by processing circuitry, cause the processing circuitry to: receive, at the mobile wallet, a bill including a total amount that is due to a merchant; activate a bill split mode of the mobile wallet for funding a virtual account to pay the bill; receive, via near-field communication (NFC) circuitry of the mobile device, an indication from a second mobile device, the indication including payment information; fund the virtual account with a first amount drawn via the payment information and a second amount drawn from an account of the mobile wallet; and execute payment of the bill, in response to funding the virtual account with a total amount of the bill, using the mobile device.

In Example 14, the subject matter of Example 13 includes, wherein the first and second amount are each equal to half of the total amount of the bill.

In Example 15, the subject matter of Examples 13-14 includes, wherein to activate the bill split mode, the instructions are further configured to cause the processing circuitry to activate the bill split mode based on a user selection on a display device of the mobile device.

In Example 16, the subject matter of Examples 13-15 includes, wherein to fund the virtual account, the instructions are further configured to cause the processing circuitry to fund the virtual account with a third amount received via a second indication including second payment information from a third mobile device.

In Example 17, the subject matter of Examples 13-16 includes, wherein the instructions are further configured to cause the processing circuitry to output for display, in a user interface corresponding to the mobile wallet on a display device of the mobile device, an image corresponding to the payment information of the second mobile device in response to receiving the indication.

In Example 18, the subject matter of Examples 13-17 includes, wherein the first amount and the second amount are different amounts that, when added together, equal the total amount of the bill.

In Example 19, the subject matter of Examples 13-18 includes, wherein the indication received from the second mobile device includes a limit to the first amount.

In Example 20, the subject matter of Examples 13-19 includes, wherein the indication received from the second mobile device includes a time limit for executing payment of the bill with the payment information.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
receiving, at a mobile wallet executing on a mobile device, a bill including a total amount that is due to a merchant;
activating, using a processor of the mobile device, a bill split mode of the mobile wallet by creating a virtual account to pay the bill;
receiving, via near-field communication (NFC) circuitry of the mobile device, an indication from a second mobile device, the indication including payment information;
funding the virtual account with a first amount drawn via the payment information and a second amount drawn from an account of the mobile wallet;
executing payment of the bill from the virtual account in a single payment, in response to funding the virtual account with a total amount of the bill, using the mobile device; and
deleting the virtual account in response to executing payment of the bill.

2. The method of claim 1, wherein the first and second amount are each equal to half of the total amount of the bill.

3. The method of claim 1, wherein activating the bill split mode includes activating the bill split mode based on a user selection on a display device of the mobile device.

4. The method of claim 1, wherein funding the virtual account includes funding the virtual account with a third amount received via a second indication including second payment information from a third mobile device.

5. The method of claim 1, further comprising, displaying, in a user interface corresponding to the mobile wallet on a display device of the mobile device, an image corresponding to the payment information of the second mobile device in response to receiving the indication.

6. The method of claim 1, wherein the first amount and the second amount are different amounts that, when added together, equal the total amount of the bill.

7. The method of claim 1, wherein executing payment of the bill includes using the NFC circuitry of the mobile device to communicate with a point of sale device of the merchant.

8. The method of claim 1, wherein the indication received from the second mobile device includes a limit to the first amount.

9. The method of claim 1, wherein the indication received from the second mobile device includes a time limit for executing payment of the bill with the payment information.

10. The method of claim 1, further comprising sending a payment request to the second mobile device, and wherein receiving the indication from the second mobile device includes receiving the indication in response to the payment request.

11. The method of claim 1, wherein receiving the bill includes capturing, using a camera of the mobile device, an image of the bill and extracting the total amount from the image.

12. The method of claim 11, further comprising identifying the second amount based on a user selection in the mobile wallet of a line item of the bill generated from the image.

13. At least one non-transitory machine-readable medium including instructions for operation of a mobile wallet on a mobile device, which when executed by processing circuitry, cause the processing circuitry to:
receive, at the mobile wallet, a bill including a total amount that is due to a merchant;
activate a bill split mode of the mobile wallet by creating a virtual account to pay the bill;
receive, via near-field communication (NFC) circuitry of the mobile device, an indication from a second mobile device, the indication including payment information;
fund the virtual account with a first amount drawn via the payment information and a second amount drawn from an account of the mobile wallet;
execute payment of the bill from the virtual account in a single payment, in response to funding the virtual account with a total amount of the bill, using the mobile device; and
delete the virtual account in response to executing payment of the bill.

14. The at least one machine-readable medium of claim 13, wherein the first and second amount are each equal to half of the total amount of the bill.

15. The at least one machine-readable medium of claim 13, wherein to activate the bill split mode, the instructions are further configured to cause the processing circuitry to activate the bill split mode based on a user selection on a display device of the mobile device.

16. The at least one machine-readable medium of claim 13, wherein to fund the virtual account, the instructions are further configured to cause the processing circuitry to fund the virtual account with a third amount received via a second indication including second payment information from a third mobile device.

17. The at least one machine-readable medium of claim 13, wherein the instructions are further configured to cause the processing circuitry to output for display, in a user interface corresponding to the mobile wallet on a display device of the mobile device, an image corresponding to the payment information of the second mobile device in response to receiving the indication.

18. The at least one machine-readable medium of claim 13, wherein the first amount and the second amount are different amounts that, when added together, equal the total amount of the bill.

19. The at least one machine-readable medium of claim 13, wherein the indication received from the second mobile device includes a limit to the first amount.

20. The at least one machine-readable medium of claim 13, wherein the indication received from the second mobile device includes a time limit for executing payment of the bill with the payment information.
